(19) United States
(12) Patent Application Publication
(10) Pub. No.: US 2007/0183422 A1
(43) Pub. Date: Aug. 9, 2007

(54) Method and apparatus to facilitate multicast transmissions using a shared infrastructure-supplied source

(76) Inventors: Cynthia M. Jung, Menlo Park, CA (US); Jheroen P. Dorenbosch, Paradise, TX (US)

Correspondence Address: MOTOROLA, INC., 1303 EAST ALGONQUIN ROAD, IL01/3RD, SCHAUMBURG, IL, 60196, US

(21) Appl. No.: 11/348,206

(22) Filed: Feb. 6, 2006

(51) Int. Cl. H04L 12/56

(52) U.S. Cl. 370/390

(57) ABSTRACT

A process (100) may be implemented subsequent to facilitating (101), for a first end user, a transmission of at least one data packet for a first multicast transmission using an infrastructure-supplied source address. This process can generally comprise using (104) that infrastructure-supplied source address to facilitate transmission of at least one data packet for a second end user for a second multicast transmission.

### TECHNICAL FIELD

This invention relates generally to data packet communications and more particularly to multicast transmissions of mobile devices.

### BACKGROUND

Multicast transmissions are known in the art, as are Mobile Internet Protocol (IP)-based communications. The prior art also provides for the combination of these two methodologies. The prior art describes, for example, permitting a mobile node to use a collocated care-of-address as the source Internet Protocol address when effecting a multicast transmission.

Such an approach, however, presents numerous intrinsic problems. Such problems can be particularly evident, for example, when seeking to employ this approach in conjunction with an application setting that employs a multicast routing protocol such as Protocol Independent Multicast-Sparse Mode (PIM-SM) between supporting routers. Multicast routing protocols such as PIM-SM offer certain desirable advantages such as working to optimize network resource usage. For example, PIM-SM supports the pruning of a corresponding multicast distribution tree during a given multicast transmission and this, in turn, removes redundant branches. When all multicast group members are serviced by a common router, a common router interface, or a shared base station, the corresponding backhaul resources of the network will be relieved of the corresponding bearer traffic.

Such multicast routing protocols also typically necessitate, however, a relatively complicated multi-step process at the start of a multicast transmission that requires multiple packets, such as a talk spurt transmitted using multicast Voice over IP. This process provides, for example, for ascertaining and establishing various kinds of state information at various routers within the network as correspond to the transmission. Because each multicast source end user will present a differing local source address, this multi-step process must be repeated for each subsequent multicast source end user. Such repetition, in turn, can represent a considerable allocation of network resources that might otherwise be available for other purposes.

### BRIEF DESCRIPTION OF THE DRAWINGS

The above needs are at least partially met through provision of the method and apparatus to facilitate multicast transmissions using a shared infrastructure-supplied source address described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a process may be implemented subsequent to facilitating, for a first end user, a transmission of at least one data packet for a first multicast transmission using an infrastructure-supplied source address. This process can generally comprise using that infrastructure-supplied source address to facilitate transmission of at least one data packet for a second end user for a second multicast transmission.

Depending upon the circumstances as pertain to a given application setting, the multicast destination address of this second multicast transmission can be different from the multicast destination address of the first multicast transmission or it can be the same. This invention can be most advantageously used, however, when the second and the first multicast transmissions use the same multicast destination address. By one approach this usage of the infrastructure-supplied source address can comprise using the same Protocol Independent Multicast-Sparse Mode distribution tree to facilitate the transmission for the second end user as was used to facilitate the transmission for the first end user.

These teachings are suitable for use with an infrastructure-supplied source address having any of a wide variety of sources and/or which has been selected via any of a wide variety of methodologies. By one approach this infrastructure-supplied source address can be associated with only a single subnet. By another approach this infrastructure-supplied source address can be associated with a plurality of subnets. If desired, the infrastructure-supplied source address can comprise an address that has been substituted (by, for example, a base station) for a source address as was initially provided by the second end user). By another approach, the infrastructure-supplied source address may be provided by, for example, a Foreign Agent (FA) or by having the first and second end user agree upon selection of a particular subnet-based address to use as the infrastructure-supplied source address.

So configured, these teachings permit a wide variety of options to now be available to a network designer and/or administrator. For example, by appropriate application of these teachings, transmissions may be facilitated using Protocol Independent Multicast-Sparse Mode techniques without requiring a full compliment of PIM-SM (or other multicast routing protocol) state-establishment optimization steps to be taken with each and every multicast source end user. This, in turn, can greatly relieve network resources (and backhaul resources).

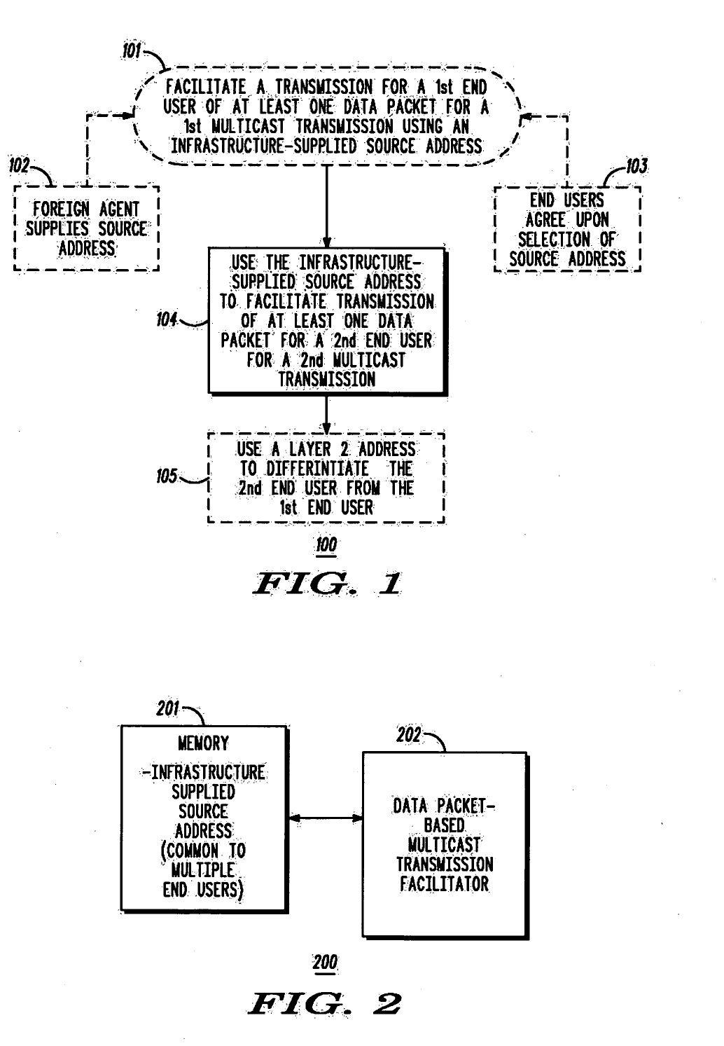

These and other benefits may become clearer upon making a thorough review and study of the following detailed description. Referring now to the drawings, and in particular to FIG. 1, these teachings provide a process 100 that can be effected subsequent to facilitating 101 a transmission for a first end user of at least one data packet for a first multicast transmission that uses an infrastructure-supplied source address. Multicast transmissions are generally known in the art and require no further description here. As used herein, “end user” will be understood to refer to, for example, any of a wide variety of wired and wireless end user platforms including both stationary and mobile variants thereof. By one approach, the first end user may be using Mobile Internet Protocol (MIP) (such as, but not limited to, Internet Protocol Version 4) to facilitate this multicast transmission.

The infrastructure-supplied source address itself may comprise, for example, a corresponding subnet source address. As one example thereof, the infrastructure-supplied source address may comprise an address that is allocated to a particular subnet to which the first end user is then presently attached. By one approach, this infrastructure-supplied source address may be associated with and used on a plurality of subnets if so desired. For example, this infrastructure-supplied source address can be associated with a plurality of subnets as are attached to a common router or base station.

There are other ways by which this infrastructure-supplied source address may be supplied. For example, those skilled in the art will understand and appreciate that a MIP Foreign Agent (FA) as is known in the art can be used to optionally provide (102) such an infrastructure-supplied source address. The FA may be associated with or located on the router or on the base station. As another example, if desired, various end users (including, for example, the first end user mentioned above) can agree (103) amongst each other with respect to selecting a particular subnet-based address to use as the infrastructure-supplied source address. (Various ways and protocols exist by which such a selection could be realized amongst a distributed user base in this regard.)

By one approach this multicast transmission can be facilitated using the Protocol Independent Multicast-Sparse Mode (PIM-SM) multicast routing protocol as is known in the art. Accordingly, a PIM-SM distribution tree will be formed via a corresponding establishment process and then pruned as appropriate and possible to eliminate redundant legs/routes when supporting additional data packet transmissions of this first end user with respect to this first multicast transmission. Such techniques are known in the art. Accordingly, for the sake of brevity, additional elaboration regarding such techniques will not be presented here.

This process 100 then provides for using 104 this infrastructure-supplied source address to facilitate transmission of at least one data packet for a second end user for a second multicast transmission (presuming that such an opportunity presents itself). This second end user will typically comprise a different end user than the first end user though exceptions may occur at least to an extent. For example, the first end user may become engaged in multitasking such that the first end user becomes a source for two separate multicast transmissions. It will also be understood and appreciated that the second multicast transmission may, or may not, be to the same multicast destination address as the first multicast transmission.

The precise manner by which the infrastructure-supplied source address is used 104 to facilitate such a transmission can vary with the specific needs, requirements, and capabilities as correspond to a given application setting. By one approach, when a PIM-SM distribution tree was used to facilitate the first multicast transmission, this usage can comprise, at least in part, using that same PIM-SM distribution tree to facilitate the second end user's multicast transmission. By this approach, the same PIM-SM distribution tree (which has already been presumably pruned to an optimum condition) as was previously developed for the first end user via a series of corresponding steps is reused for the second end user without requiring a rebuild of that pruned PIM-SM distribution tree. This, in turn, permits supporting the described transmission(s) without requiring updating of routing-related state information when using the infrastructure-supplied source address. This is particularly so when the first multicast transmission and the second multicast transmission use the same multicast destination address.

As noted earlier, if desired, the infrastructure-supplied source address may be associated with a plurality of subnets as are attached to a common router. When this common router comprises a base station, this process 100 can further comprise, if desired, using the protocol contents of a corresponding wireless interface to determine a particular one of the plurality of subnets as corresponds to both the first end user and the second end user. This approach, in turn, may reduce the amount of information (for example, so-called “state”) that needs to be stored in the routers of the system.

If desired, the infrastructure-supplied source address can be provided and used by a network element other than the end user(s) itself. For example, if desired, a corresponding base station can be configured and arranged to substitute the above-described infrastructure-supplied source address for a source address as might otherwise be initially provided by the second end user. In such a case, those skilled in the art will understand and appreciate that such an infrastructure-supplied source address may comprise, for example, an address that is unique to each subnet as may be served by a common router. As another example, such an infrastructure-supplied source address may comprise an address that is common to at least two subnets as may be served by a common router. Particular selections in this regard will likely depend upon the particular circumstances that characterize a given specific application setting. Those skilled in the art will further appreciate that, if desired, the router may be incorporated into the base station.

Depending upon the application setting, if desired, this process 100 can also optionally provide for using 105, at least in part, a Layer 2 address to differentiate the second end user from the first end user. Such a step may be helpful in settings where both the first and second end user are providing a common infrastructure-supplied source address as their source address when effecting their respective multicast transmissions as described herein.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, the apparatus 200 comprises a memory 201 and a data packet-based multicast communication transmission facilitator 202 that operably couples thereto. In this example the memory 201 has stored therein the above-described infrastructure-supplied source address that is common to a plurality of end users. The data packet-based multicast communication transmission facilitator 202 in this illustrative example is arranged and configured to use the infrastructure-supplied source address as a source address for corresponding uplink multicast data packets. As noted above, and particularly when both multicast transmissions are using the same multicast destination address, this can comprise, if desired, using the same Protocol Independent Multicast-Sparse Mode distribution tree to facilitate transmitting the corresponding uplink multicast data packets of a second end user as was formed and employed on behalf of a first end user as described above.

Those skilled in the art will recognize and appreciate that these teachings can be readily deployed in a variety of ways. As a result, the above-described apparatus 200 can comprise, at least in part, an end user platform and/or an infrastructure platform (such as a base station).

Those skilled in the art will further recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, multicast transmissions are readily supported using existing Internet Protocol standards that employ a local Internet Protocol address that avoids a need to rely upon Home Agent-based tunneling. These teachings are also able to rely upon the optimization advantages offered by multicast routing protocols such as PIM-SM-based multicast routing while effectively leveraging the use of an already established distribution tree (or other optimization tool or result) on behalf of additional end users and/or multicast transmissions. In particular, the use of a common infrastructure-supplied source address aids in avoiding a need for one or more infrastructure elements to readdress their state settings and records with respect to these end users/multicast transmissions, particularly if most or all end users use the same multicast destination address.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising, subsequent to facilitating for a first end user a transmission of at least one data packet for a first multicast transmission using an infrastructure-supplied source address:
using the infrastructure-supplied source address to facilitate transmission of at least one data packet for a second end user for a second multicast transmission.

2. The method of claim 1 wherein using the infrastructure-supplied source address to facilitate transmission of at least one data packet for a second end user for a second multicast transmission comprises using the infrastructure-supplied source address to facilitate transmission of at least one data packet for a second end user for a second multicast transmission to a same multicast destination address as was used for the first multicast transmission using a same Protocol Independent Multicast-Sparse Mode (PIM-SM) distribution tree to facilitate the transmission for the second end user as was used to facilitate the transmission for the first end user.

3. The method of claim 1 wherein the infrastructure-supplied source address comprises, at least in part, an Internet Protocol source address that comprises, at least in part, a subnet source address.

4. The method of claim 1 wherein the first end user and the second end user use Mobile Internet Protocol employing a local Internet Protocol address to facilitate their respective multicast transmissions.

5. The method of claim 1 further comprising:
using, at least in part, a Layer 2 address to differentiate the second end user from the first end user.

6. The method of claim 1 wherein using the infrastructure-supplied source address to facilitate transmission of at least one data packet for a second end user for a second multicast transmission further comprises not updating routing-related state information when using the infrastructure-supplied source address to facilitate transmission of at least one data packet for a second end user.

7. The method of claim 1 wherein the first multicast transmission and the second multicast transmission comprise one of:
a same multicast destination address;
different multicast destination addresses.

8. The method of claim 1 further comprising:
associating the infrastructure-supplied source address with a plurality of subnets.

9. The method of claim 8 wherein associating the infrastructure-supplied source address with a plurality of subnets further comprises associating the infrastructure-supplied source address with a plurality of subnets as are attached to a common router.

10. The method of claim 9 wherein the common router comprises a basestation and wherein the method further comprises:
using protocol contents of a wireless interface to determine a particular one of the plurality of subnets as corresponds to the first end user and the second end user.

11. The method of claim 1 wherein using the infrastructure-supplied source address to facilitate transmission of at least one data packet for a second end user for a second multicast transmission further comprises:
substituting the infrastructure-supplied source address for a source address as has been initially provided by the second end user.

12. The method of claim 11 wherein the infrastructure-supplied source address comprises one of:
an address that is unique to each subnet as may be served by a common router;
an address that is common to at least two subnets as may be served by a common router.

13. The method of claim 1 further comprising:
using a Foreign Agent (FA) to provide the infrastructure-supplied source address.

14. The method of claim 1 further comprising:
the first end user and the second end user agreeing upon selection of a particular subnet-based address to use as the infrastructure-supplied source address.

15. The method of claim 1 wherein the infrastructure-supplied source address comprises an address allocated to a particular subnet to which the first end user is attached.

16. An apparatus comprising:
a memory having stored therein an infrastructure-supplied source address that is common to a plurality of end users;
a data packet-based multicast communication transmission facilitator operably coupled to the memory and being arranged and configured to use the infrastructure-supplied source address as a source address for corresponding uplink multicast data packets.

17. The apparatus of claim 16 wherein the apparatus comprises, at least in part, an end user platform.

18. The apparatus of claim 16 wherein the apparatus comprises, at least in part, an infrastructure platform.

19. The apparatus of claim 16 wherein the data packet-based multicast communication transmission facilitator is further configured and arranged to use the same Protocol Independent Multicast-Sparse Mode (PIM-SM) distribution tree to facilitate transmitting the corresponding uplink multicast data packets.

20. The apparatus of claim 16 wherein the data packet-based multicast communication transmission facilitator comprises means for, subsequent to facilitating for a first end user a transmission of at least one data packet for a first multicast transmission using the infrastructure-supplied source address, using the same infrastructure-supplied source address to facilitate transmission of at least one data packet for a second end user for a second multicast transmission.
